(19) United States
(12) Patent Application Publication
(10) Pub. No.: US 2004/0140034 A1
(43) Pub. Date: Jul. 22, 2004

(54) Inner tube cover

(76) Inventors: Donald G. Baudoin, Mesa, AZ (US); Laura A. Baudoin, Mesa, AZ (US)

Correspondence Address: Jordan M. Meschkow, Meschkow & Gresham, PLC, Suite 409, 5727 North Seventh Street, Phoenix, AZ, 85014, US

(21) Appl. No.: 10/348,428

(22) Filed: Jan. 21, 2003

(51) Int. Cl. B60C 5/08; B60C 5/04

(52) U.S. Cl. 152/512; 152/450

(57) ABSTRACT

An inner tube cover (20) includes a cover unit (26) and a carry bag (56) coupled to the cover unit (26) and sized to accommodate storage of the cover unit (26). The cover unit (26) includes a top panel (22) and a side panel (24) coupled about a perimeter of the top panel (22). The side panel (24) includes a tubular hem portion (36). A cord (38) is directed through the tubular hem portion (36) and extends from an opening (44) in the tubular hem portion (36). A cord lock (48) fastens to the cord (38). When the cord (38) is drawn tight and cord lock (48) is secured, cover unit (26) substantially shrouds an inner tube (72).

### TECHNICAL FIELD OF THE INVENTION

The present invention relates to the field of recreational equipment for water-based leisure activities. More specifically, the present invention relates to a cover for an inner tube used for tubing.

### BACKGROUND OF THE INVENTION

A popular summertime pastime is tubing. Tubing involves floating on an inner tube in a body of water, such as, a lake, a river, a stream, and so forth. Indeed, many individuals find tubing to be one of the most leisurely and intimate ways to experience the water. Tubing provides opportunities for socialization, for staying cool on a hot summer day, for viewing wildlife, and for exploring nooks and crannies of the ecosystem through which the individual is floating.

Although usable for the purpose of tubing, an inner tube is not necessarily an optimal flotation vehicle in terms of comfort and convenience. For example, because of their awkward shape and lack of handles, inflated inner tubes are difficult to carry and/or hold onto whether in or out of the water. In addition, it is sometimes difficult to relax in an inner tube due to the doughnut-like structure of the inner tube and due to the slippery condition of a wet inner tube. For these reasons, many adults and children have to hold themselves within the inner tube, to avoid falling or slipping through the center hole. In addition, an inner tube has a protruding valve stem through which air passes when inflating the tube. This valve stem is typically located along the tube wall within the center hole. Individuals slipping through the center hole tend to get scratched or poked by the valve stem.

An inner tube is typically fabricated from a black rubber material. Unfortunately, black inner tubes get uncomfortably hot in the summer sunshine. Furthermore, individuals tend to get dirty from the black rubber material. More critically, some individuals are sensitive to the rubber. Those individuals can get a rash on their arms, legs, back, and chest in response to prolonged contact with the rubber material, especially when the rider is sweating in those areas contacting the hot rubber.

To alleviate the problem of contact with the rubber, some individuals will drape a cover, such as, a towel or sheet, over the inner tube then attempt to sit on the cover. Unfortunately, a draped cover continually requires readjustment over the tube. In addition, since the cover is not coupled to the tube, the cover can easily become separated from the tube if the tube flips over or the rider falls out of the tube. Furthermore, the black rubber of the inner tube can discolor or stain the cover.

Inner tubes are typically rented from a recreational facility, and tube rental agreements usually dictate that each individual is financially responsible for his or her rented inner tube. A waterway configured for tubing is likely to have many individuals floating on the waterway on any given day. Accordingly, there may be many inner tubes sitting around at the launch location, intermediate picnic sites, and the disembark location. Unfortunately, inner tubes tend to look quite similar. With such similar looking tubes, an individual can readily misplace or lose their rented inner tube, and fall subject to paying a penalty for the loss.

An inner tube is a doughnut-shaped, flexible rubber tube inflated inside a tire to bear the weight of a vehicle. It goes without saying then that inner tubes do not have pockets or compartments for the storage of personal belongings, sunscreen, drinks, and/or trash. Non-secured items can be lost in the water or damaged by the water. Loss or damage of personal belongings is highly undesirable for the individual and loss of belongings and/or trash in the water contributes to pollution of the waterway.

The above problems lead to discomfort, inconvenience, and damage to the ecosystem, thus making an otherwise relaxing leisure experience less pleasant. Accordingly, what is needed is an inner tube cover that mitigates the aforementioned problems.

### SUMMARY OF THE INVENTION

Accordingly, it is an advantage of the present invention that an inner tube cover for an inner tube is provided.

It is another advantage of the present invention that an inner tube cover is provided that offers comfortable support for an inner tube user.

Another advantage of the present invention is that the inner tube cover is provides a barrier between the inner tube and the user of the inner tube.

Another advantage of the present invention is that an inner tube cover is provided that is an aid in ready identification of a user's inner tube.

Yet another advantage of the present invention is that an inner tube cover is provided that is fastened to an inner tube and enables a user to secure their possessions to or within the inner tube cover.

The above and other advantages of the present invention are carried out in one form by an inner tube cover that includes a top panel and a side panel having a first longitudinal edge coupled to an edge of the top panel and having a second longitudinal edge exhibiting a tubular hem portion. A cord is directed through the tubular hem portion.

The above and other advantages of the present invention are carried out in another form by an inner tube cover that includes a cover unit and a carry bag. The cover unit includes a top panel and a side panel having a first longitudinal edge coupled to an edge of the top panel and having a second longitudinal edge exhibiting a tubular hem portion, the tubular hem portion including an opening. A cord is directed through the tubular hem portion, and a first end and a second end of the cord extend from the opening in the tubular hem portion. A cord lock engages each of the first and second cord ends, the cord lock being slidable and lockable along the cord. The carry bag is coupled to the side panel and is sized to accommodate storage of the cover unit.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a front view of an inner tube cover in accordance with a preferred embodiment of the present invention;

FIG. 2 shows a front view of a top panel of the inner tube cover of FIG. 1;

FIG. 3 shows a front view of a side panel of the inner tube cover of FIG. 1;

FIG. 4 shows a sectional view of the side panel of FIG. 3 along section line 4-4;

FIG. 5 shows a perspective view of a portion of the inner tube cover exposing a carry bag located on an interior surface;

FIG. 6 shows a perspective view of removal of a cover unit of the inner tube cover from the carry bag of FIG. 5;

FIG. 7 shows a perspective view of the inner tube cover being installed on an inner tube;

FIG. 8 shows a perspective view of a bottom side of the inner tube cover secured to the inner tube; and

FIG. 9 shows a perspective view of a top side of the inner tube cover secured to the inner tube.

### DETAILED DESCRIPTION OF THE PREFERRED EMBODIMENTS

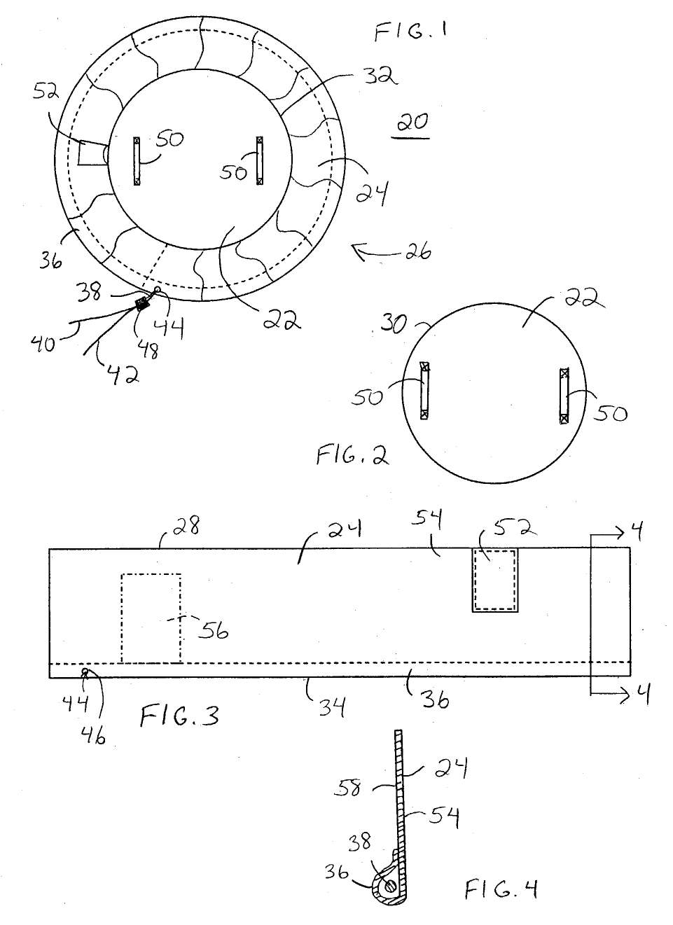

Referring to FIGS. 1-4, FIG. 1 shows a front view of an inner tube cover 20 in accordance with a preferred embodiment of the present invention. FIG. 2 shows a front view of a top panel 22 of inner tube cover 20. FIG. 3 shows a front view of a side panel 24 of inner tube cover 20, and FIG. 4 shows a sectional view of side panel 24 of FIG. 3 along section lines 4-4.

Top panel 22 and side panel 24 of inner tube cover 20 collectively form a cover unit 26 that encircles an inner tube (not shown). Side panel 24 has a first longitudinal edge 28 coupled to an edge 30 of top panel 22, thus forming a seam 32. Side panel 24 has a second longitudinal edge 34 having a tubular hem portion 36. A cord 38 is directed through tubular hem portion 36, such that a first end 40 and a second end 42 of cord 38 extend from an opening 44 in tubular hem portion 36. In a preferred embodiment, a grommet 46 is fastened to tubular hem portion 36 about opening 44 for lining opening 44. Grommet 46 provides additional durability of tubular hem portion 36 at opening 44.

A cord lock 48 is fastened along first and second ends 40 and 42 of cord 38. Cord lock 48 is slidable and lockable along cord 38 and enables cord 38 to act as a drawstring for tightening and securing inner tube cover 20 around an inner tube, discussed below. Cord lock 48 is a conventional cord lock, or cord fastener, provided, for example, by UMX—Universal Mercantile Exchange, Inc., Baldwin Park, Calif. Cord lock 48 may be a dual-hole cord lock for accommodating first and second ends 40 and 42, respectively, of cord 38.

Handles 50 are secured to top panel 22. In an exemplary embodiment, handles 50 may be made from webbing, such as automotive seat belt webbing or some other durable, yet pliable, material. Inner tube cover 20 further includes a pocket 52 sewn to an exterior surface 54 of side panel 24, and a carry bag 56 (shown in ghost form) sewn to an interior surface 58 of side panel 24.

Pocket 52 serves as a compartment on the outside of inner tube cover 20 in which a user may place personal belongings, drinks, trash, and so forth, when tubing. Pocket 52 may be outfitted with or without a closure, and may or may not be fabricated from waterproof material. Carry bag 56 serves as a compartment for storage of cover unit 26 when not in use. Carry bag 56 is fixedly coupled by sewing to cover unit 26 so that carry bag 56 is always readily available.

In a preferred embodiment, inner tube cover 20 is formed from cloth. Cloth, i.e., a woven fabric, is available in many colors, textures, and styles so that an inner tube outfitted with inner tube cover 20 can be readily distinguished from a group of inner tubes. In addition, the cloth material covers the inner tube to provide protection for the inner tube against damaging ultraviolet rays from the sun, and against sticks, rocks, or other sharp objects that may be present in the water. In addition, the cloth material is comfortable for the user. More particularly, cloth material is cooler than the black rubber inner tube and provides protection against rashes from prolonged contact with the rubber inner tube.

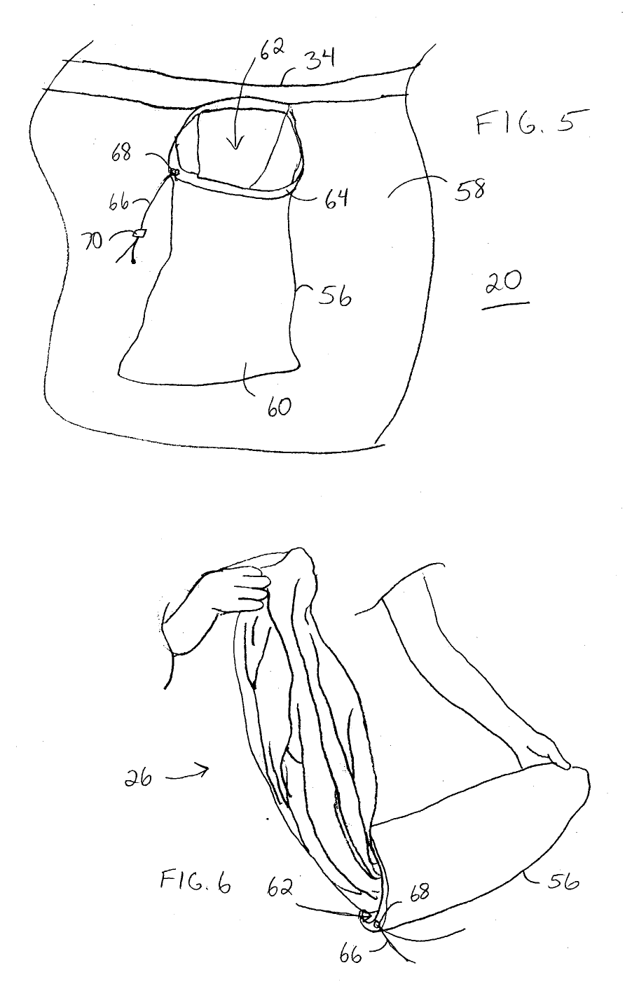

Referring to FIGS. 5-6, FIG. 5 shows a perspective view of a portion of inner tube cover 20 exposing carry bag 56 located on interior surface 58. FIG. 6 shows a perspective view of removal of cover unit 26 from carry bag 56. As mentioned briefly above, cover unit 26 is advantageously stowed in carry bag 56 when not in use so that inner tube cover 20 is readily transportable. Accordingly, a user can bring his or her inner tube cover 20 to a tube rental facility, rent an inner tube, and subsequently install inner tube cover 20 on the rented inner tube.

Carry bag 56 is positioned proximate second longitudinal edge 34 of side panel 24 and sewn into place. Carry bag 56 includes a cloth body 60 having an opening 62, a casing 64 about a perimeter of opening 62, and a drawstring 66 inserted into casing 64 and extending from an aperture 68 in casing 64. Carry bag 56 further includes a cord lock 70 installed on drawstring 66. Like cord lock 48 (FIG. 1), cord lock 70 is slidable and lockable along drawstring 66.

Carry bag 56 is sized to accommodate cover unit 26. In operation, cover unit 26 is passed through opening 62 for storage in carry bag 56. Drawstring 66 is drawn and cinched with cord lock 70 to close opening 62. When ready for use, cord lock 70 is unlocked, and drawstring 66 is loosened thereby enlarging opening 62. A user then simply pulls cover unit 26 out of carry bag 56 for deployment.

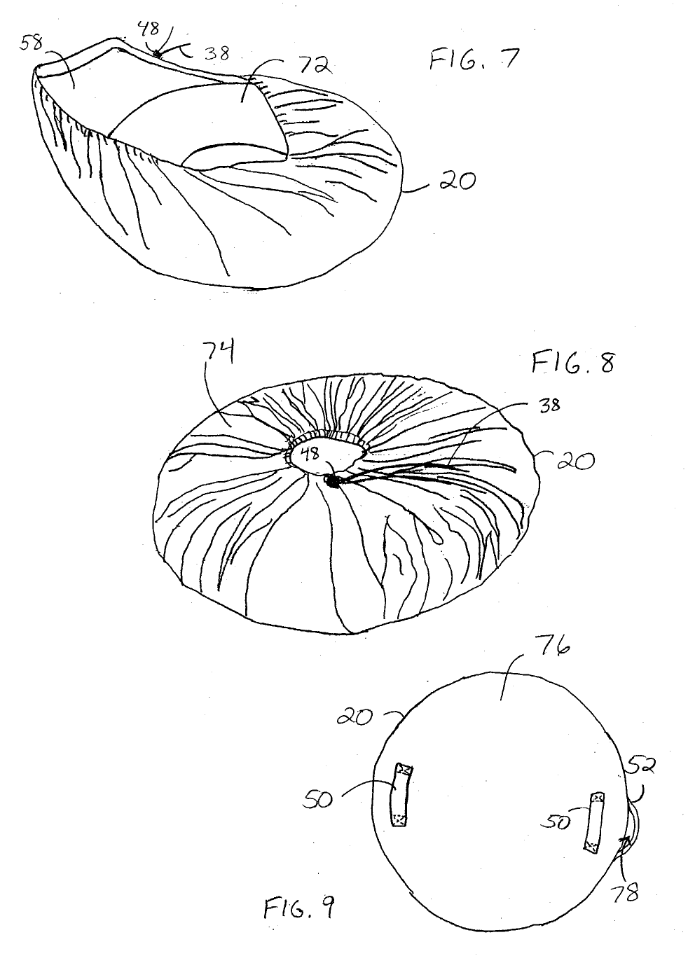

FIG. 7 shows a perspective view of inner tube cover 20 being installed on an inner tube 72. Once cover unit 26 (FIG. 6) is deployed from carry bag 56 (FIG. 6), cord lock 48 is released, and cord 38 is loosened, as needed, to open inner tube cover 20. Inner tube cover 20 is placed around the inflated inner tube 72, with interior surface 58 of inner tube cover 20 facing inner tube. Cord 38 is then drawn tight to secure inner tube cover 20 about inner tube 72.

Referring to FIGS. 8-9, FIG. 8 shows a perspective view of a bottom side 74 of inner tube cover 20 secured to inner tube 72 (FIG. 7), and FIG. 9 shows a perspective view of a top side 76 inner tube cover 20 secured to the inner tube.

Once cord 38 is drawn tight and cord lock 48 is locked, inner tube 72 is substantially shrouded by inner tube cover 20. The shrouding of inner tube 72 protects inner tube from ultraviolet rays from above, and sticks, rocks, and other sharp objects from below. In addition, the user's clothing, towel, etc. is protected from the black rubber inner tube. Furthermore, the user's skin is protected from contact with the rubber and the inner tube valve stem. The excess length of cord 38 can additionally be utilized to tether another flotation device, such as a second inner tube, to inner tube 72. The second tube can contain another individual and/or personal belongings, such as a cooler, radio, towels, and so forth.

Bottom side 74 of inner tube cover 20 is configured to face toward and sit in the water, while top side 76 of inner tube cover 20 provides a comfortable and stable support for adults, children, pets, personal belongings, and so forth. In addition, handles 50 can be readily grasped by the tube rider for extra security. Furthermore, as shown, pocket 52 having an opening 78 is exposed and available for placement of and access to belongings, food, drink, sunscreen, and so forth.

In summary, the present invention teaches of an inner tube cover for an inner tube that is readily transportable and easily deployed. The fabric construction and handles provide a barrier between the inner tube and the user of the inner tube and provides comfortable support for the user. In addition, color, texture, and pattern of the fabric inner tube cover provides an aid in ready identification of a user's inner tube. The encasement of the inner tube by the inner tube cover tube protects the inner tube from sun damage and/or damage from rocks, sticks, and other sharp objects. Pockets and cord, serving as a tether line, enable a user to secure possessions to or within the inner tube cover.

Although the preferred embodiments of the invention have been illustrated and described in detail, it will be readily apparent to those skilled in the art that various modifications may be made therein without departing from the spirit of the invention or from the scope of the appended claims. For example, the inner tube cover can be adapted to include a number of pockets and/or handles. In addition, different locking mechanisms can replace the cord locks described herein.

What is claimed is:

1. An inner tube cover comprising:
a top panel;
a side panel having a first longitudinal edge coupled to an edge of said top panel and having a second longitudinal edge exhibiting a tubular hem portion; and
a cord directed through said tubular hem portion.

2. An inner tube cover as claimed in claim 1 further comprising handles secured to said top panel.

3. An inner tube cover as claimed in claim 1 wherein first and second ends of said cord extend from an opening in said tubular hem portion, and said inner tube cover further comprises a cord lock engaging each of said first and second cord ends, said cord lock being slidable and lockable along said cord.

4. An inner tube cover as claimed in claim 3 further comprising a grommet fastened to said tubular hem portion about said opening for lining said opening.

5. An inner tube cover as claimed in claim 1 wherein said top panel and said side panel are formed from a cloth material.

6. An inner tube cover as claimed in claim 1 wherein said top cover, said top panel, and said cord form a cover unit for encircling an inner tube, and said cover further comprises a carry bag coupled to said side panel and sized to accommodate storage of said cover unit.

7. An inner tube cover as claimed in claim 6 wherein said carry bag comprises:
a body having an opening;
a casing about a perimeter of said opening through which said cover unit passes for storage; and
a drawstring inserted into said casing for closing said opening.

8. An inner tube cover as claimed in claim 7 further comprising a cord lock installed on said drawstring, said cord lock being slidable and lockable along said drawstring.

9. An inner tube cover as claimed in claim 6 wherein said carry bag is formed from a cloth material.

10. An inner tube cover as claimed in claim 1 further comprising a pocket coupled to one of said top and said side panels, said pocket having an opening on an exterior side of said one of said top and side panels.

11. An inner tube cover comprising:
a top panel;
handles secured to said top panel;
a side panel having a first longitudinal edge coupled to an edge of said top panel and having a second longitudinal edge exhibiting a tubular hem portion, said tubular hem portion including an opening;
a cord directed through said tubular hem portion, a first end and a second end of said cord extending from said opening in said tubular hem portion; and
a cord lock engaging each of said first and second cord ends, said cord lock being slidable and lockable along said cord.

12. An inner tube cover as claimed in claim 11 further comprising a grommet fastened to said tubular hem portion about said opening for lining said opening.

13. An inner tube cover as claimed in claim 11 wherein said top panel and said side panel are formed from a cloth material.

14. An inner tube cover as claimed in claim 11 wherein said top cover, said top panel, and said cord form a cover unit for encircling an inner tube, and said cover further comprises a carry bag coupled to said side panel and sized to accommodate storage of said cover unit.

15. An inner tube cover comprising:
a cover unit including:
a top panel;
a side panel having a first longitudinal edge coupled to an edge of said top panel and having a second longitudinal edge exhibiting a tubular hem portion, said tubular hem portion including an opening;
a cord directed through said tubular hem portion, a first end and a second end of said cord extending from said opening in said tubular hem portion; and
a cord lock engaging each of said first and second cord ends, said cord lock being slidable and lockable along said cord; and
a carry bag coupled to said side panel and sized to accommodate storage of said cover unit.

16. An inner tube cover as claimed in claim 15 wherein said carry bag comprises:
a body having an opening;
a casing about a perimeter of said opening through which said cover unit passes for storage; and
a drawstring inserted into said casing for closing said opening.

17. An inner tube cover as claimed in claim 16 further comprising a cord lock installed on said drawstring, said cord lock being slidable and lockable along said drawstring.

18. An inner tube cover as claimed in claim 15 further comprising a pocket coupled to one of said top and said side panels, said pocket having an opening on an exterior side of said one of said top and side panels.

19. An inner tube cover as claimed in claim 15 wherein said top panel and said side panel are formed from a cloth material.

20. An inner tube cover as claimed in claim 15 wherein said carry bag is formed from a cloth material.
